(19) United States
(12) Patent Application Publication
(10) Pub. No.: US 2013/0298796 A1
(43) Pub. Date: Nov. 14, 2013

(54) Excavator Adapted for Railroad

(71) Applicant: Jeramy LeGard, Athens, TX (US)

(72) Inventor: Jeramy LeGard, Athens, TX (US)

(21) Appl. No.: 13/469,779

(22) Filed: May 11, 2012

(51) Int. Cl. B60F 1/04

(52) U.S. Cl. 105/215.2

(57) ABSTRACT

An improved excavator for use in construction and repair of railroad tracks is provided. The excavator has one set of removable flanged wheels on the backfill blade side of the excavator, and one set of retractable flanged wheels on the side opposite the backfill blade side. The excavator may also include a tow bar or tow bar receiver enabling easy transportation to and from a worksite.

### BACKGROUND OF THE INVENTION

1. Technical Field

The present invention relates to construction equipment adapted for use on a railroad work site.

2. Description of Related Art

Frequently, construction equipment is needed during construction and repair of railroad lines. A railroad line or railroad track generally comprises two rails laid over railroad ties, which are embedded in or on ballast. These components may lie above other various subgrade structures.

One piece of equipment that is particularly useful in the construction and repair of a railroad track is an excavator. An excavator generally comprises a boom and stick connected to a bucket, and a backfill blade.

Transporting such construction equipment to and from a worksite is a challenge in the industry. Typically a piece of equipment will either be driven onto or lifted via crane onto a flatbed railcar, which is pushed or pulled along the railroad by an engine towards the worksite. This method of transportation is time consuming and inefficient, especially if emergency repair work is needed. A need exists in the art for an improved excavator that allows for easy transportation to a worksite, and full use of the excavator working equipment.

### SUMMARY OF THE INVENTION

The proposed invention comprises an excavator with a boom, stick (or arm) and bucket attachment, a backfill blade, a set of removable flanged wheels on the backfill blade side of the excavator, and a set of extendable flanged wheels on the side opposite the backfill blade. In one embodiment, the invention is an excavator comprising a backfill blade side; a set of removable flanged wheels attached to the excavator on the backfill blade side; and a set of retractable flanged wheels attached to the excavator on a side opposite the backfill blade side. In another embodiment, the removable flanged wheels comprise a removable flanged wheel assembly that attaches to a structure supporting a backfill blade on the backfill blade side. In still another embodiment, the retractable flanged wheels comprise a retractable flanged wheel assembly which rotates the retractable flanged wheels between an engaged position and a disengaged position.

The removable flanged wheel assembly may also comprise at least one attaching member that engages with at least one corresponding receiving hole in the structure supporting the backfill blade. In another embodiment, at least one support pin holds the retractable flanged wheel assembly in the engaged position and disengaged position.

In another embodiment, the excavator further comprises at least one of a tow bar receiver, a tow bar mount, wherein the tow bar mount may be integral to a support structure supporting a backfill blade, or a tow hitch mount. The tow bar receiver may be affixed to the top of a backfill blade or affixed to the excavator on the side opposite the backfill blade side.

The invention allows the excavator to be pushed or towed to a worksite, and yet still allow the operator to use the work tools effectively. The invention also allows the excavator to propel itself along a railroad track. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A is a side view illustrating one embodiment of the excavator of the present invention;

FIG. 1B is a side view illustrating one embodiment of the excavator of the present invention in use;

FIG. 1C is a side view illustrating one embodiment of the excavator of the present invention in use;

FIG. 1D is a side view illustrating one embodiment of the excavator of the present invention in use;

FIG. 2 is a side view illustrating one embodiment of the excavator of the present invention being towed by a railcar;

FIG. 3A is a top exploded view illustrating one embodiment of the removable flanged wheels of the present invention;

FIG. 3B is a top view illustrating one embodiment of the removable flanged wheels of the present invention;

FIG. 4A is a perspective view illustrating one embodiment of the extendable flanged wheels of the present invention;

FIG. 4B is another perspective view illustrating one embodiment of the extendable flanged wheels of the present invention;

FIG. 5 is a front exploded view illustrating one embodiment of the tow bar of the present invention;

### DETAILED DESCRIPTION

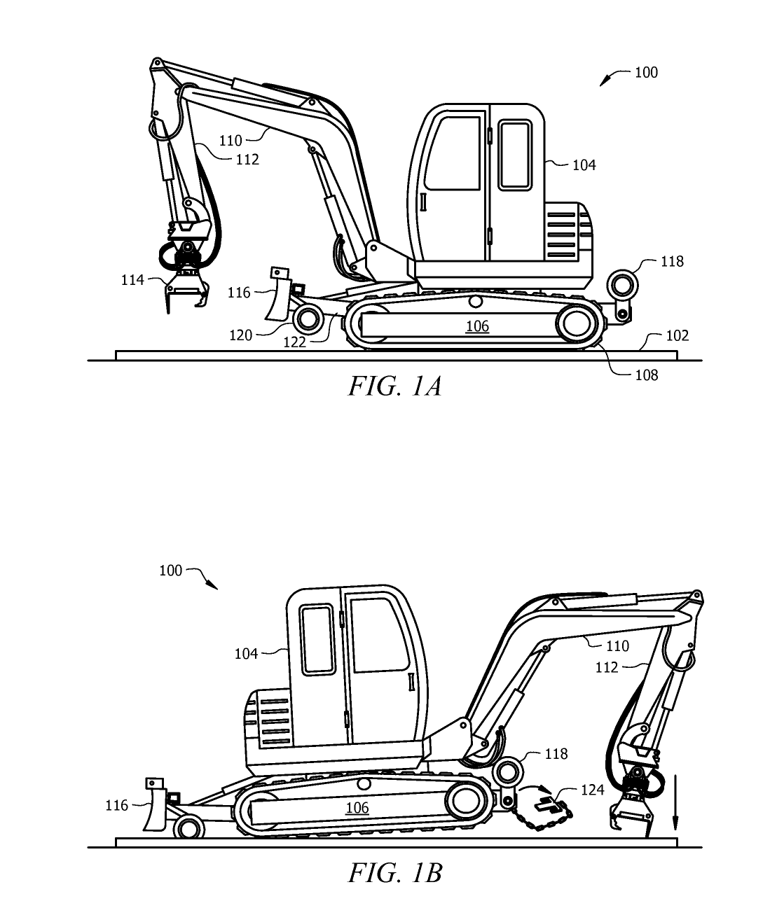

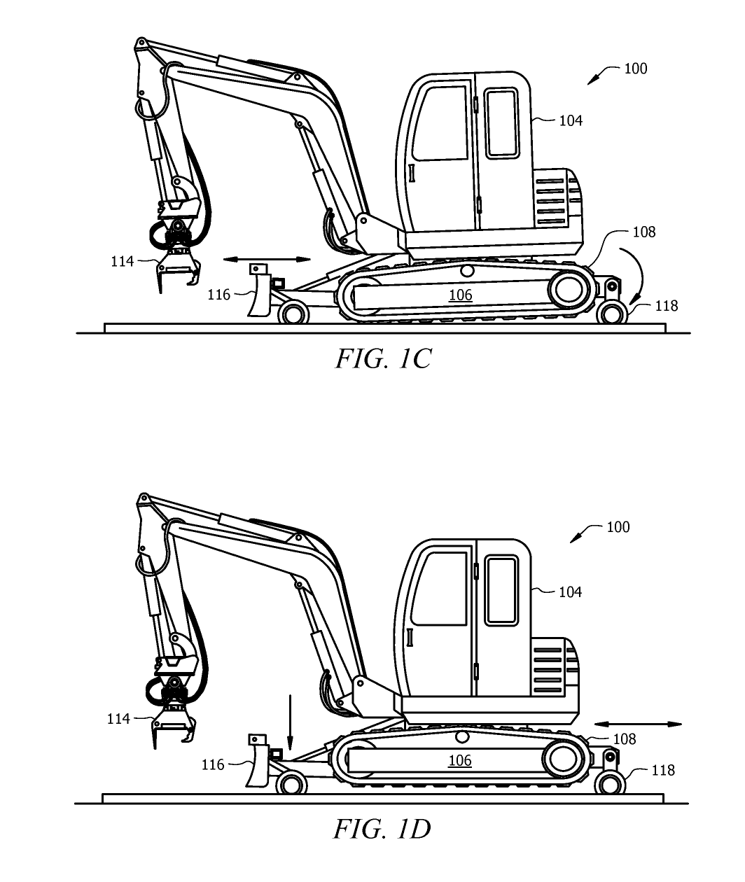

The present invention is directed to an excavator with two sets of flanged wheels configured to engage with a railroad track when extended in their downward position. In a preferred embodiment, the excavator is a mini-excavator. Excavator and mini-excavator are used interchangeably herein. FIGS. 1A through 1D depict one embodiment of the mini-excavator of the present invention in with the flanged wheels in various stages of use.

FIG. 1A depicts an excavator 100 sitting on a railroad track 102 with both sets of flanged wheels in the up or disengaged position. The excavator comprises a house 104, which contains the operator's compartment, engine, hydraulic pump and hydraulic fluid distribution components. The house 104 is attached to, and can rotate on top of, an undercarriage 106. The undercarriage 106 comprises metal or rubber drive tracks 108, drive sprockets, and associated components that enable the operator to rotate the tracks in order to propel or turn the excavator 100.

Also attached to the house are a boom 110, an arm 112, and an attachment 114. In FIG. 1A, the attachment 114 is a railroad tie grapple. The boom 110, arm 112 and attachment 114 are hydraulically operable, and allow the operator to extend, retract, turn, rotate, move, or otherwise manipulate objects using the attachment 114. A backfill blade 116 is attached to the undercarriage 106. The backfill blade 116 can be raised or lowered hydraulically by the operator.

Also depicted in FIG. 1A are two sets of flanged wheels. One set of flanged wheels is a set of retractable flanged wheels 118 which are attached to the undercarriage 106 and located on the side of the undercarriage 106 opposite the backfill blade 116. The other set of flanged wheels is a removable set of flange wheels 120, which is attached to the structure 122 that supports the backfill blade 116.

FIGS. 1B and 1C show how, in one embodiment, both sets of flanged wheels are engaged with the railroad track 102. The flanged wheels 120 attached to the backfill blade structure 112 are engaged with the railroad track by lowering the backfill blade 116 hydraulically until the wheels 120 come into contact with the railroad tracks 102. The engagement of the retractable flanged wheels 120 is a multistep process. First, the boom, arm and attachment are manipulated such that the attachment impacts the ground and lifts the side of the excavator opposite the backfill blade off the ground. The operator or a helper then removes at least one support pin 124 that holds the retractable flanged wheels 118 in the disengaged position, and manually rotates the flanged wheel assembly away from the undercarriage and down into the engaged position. The support pins 124 are then placed back into the flanged wheel assembly to retain the wheels in the engaged position, and the operator lifts the boom, arm and attachment such that the weight of the excavator is supported by the retractable wheel assembly.

As can be seen in FIG. 1C, both sets of flanged wheels are engaged with the railroad tracks. FIG. 1C also depicts the backfill blade moved down just so far that the excavator's drive tracks are also engaged with the railroad tracks. In this configuration, the excavator is capable of travelling in both directions on the railroad track under its own power. The operator merely drives the excavator forward or backward as usual using the rotation of the drive tracks as propulsion, and the flanged wheels maintain the position of the excavator on the railroad tracks.

FIG. 1D also depicts both sets of flanged wheels 118 and 120 engaged with the railroad tracks. However, in this configuration, the backfill blade has been hydraulically moved down further than depicted in FIG. 1C, thereby lifting the entire excavator off the railroad tracks so the excavator drive tracks are suspended above the railroad tracks. This allows the excavator to move freely in either direction of the railroad tracks under external force.

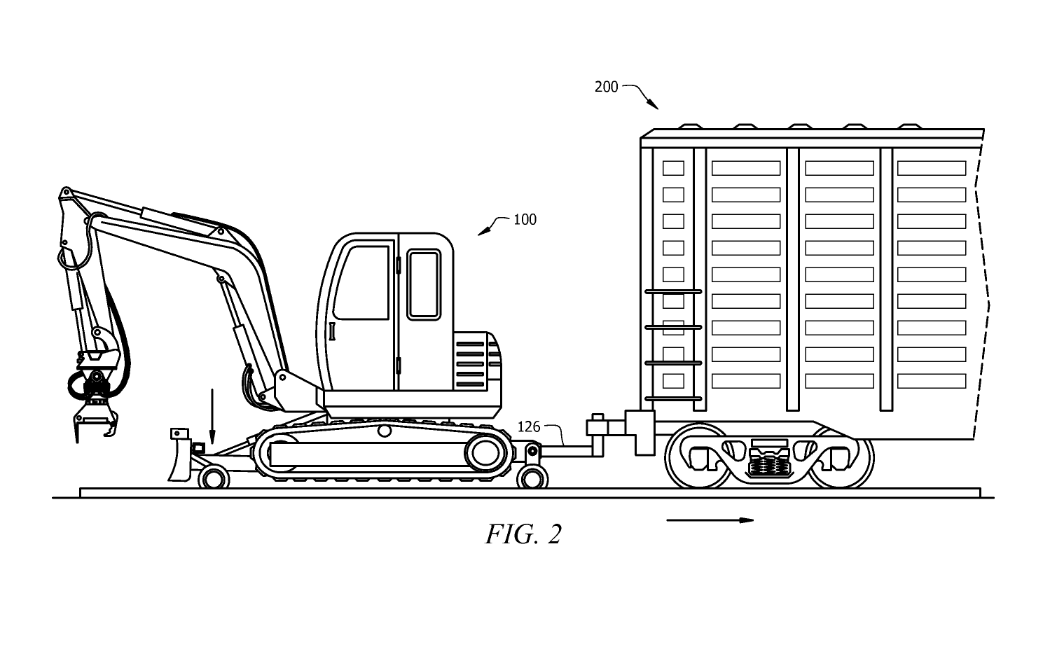

As depicted in FIG. 2, in one embodiment, the excavator 100 can be towed or pushed to a worksite by a railcar 200 using a tow bar 126. The tow bar 126 connects to the undercarriage or retractable wheel assembly on the side opposite the backfill blade.

When the excavator arrives at the worksite, the steps for engaging the flanged wheels described above are reversed to allow the excavator to move freely about the worksite. In particular, the operator manipulates the boom, arm and attachment such that they support the weight of the excavator on the side opposite the backfill blade. The operator or a helper then removes the support pins from the retractable flanged wheel assembly, rotates the wheel assembly back up into the disengaged position, and replaces the support pins. The operator can then remove the weight support provided by the boom, arm and attachment, and lift the backfill blade and drive the excavator around the worksite as usual.

Because the flanged wheels on the backfill blade side of the excavator are attached to the structure that supports the backfill blade and extend down below the blade, the backfill blade suffers from a reduced range of motion than it would have absent the flanged wheel assembly being attached thereto. So, in a preferred embodiment, the flanged wheels attached to the backfill blade structure are easily removable.

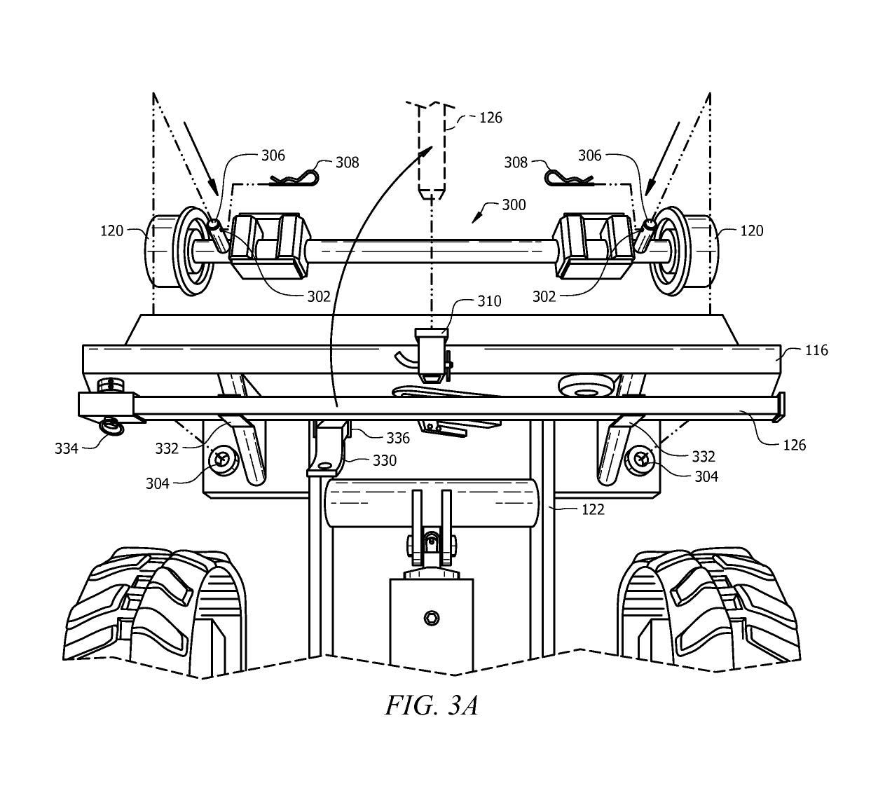

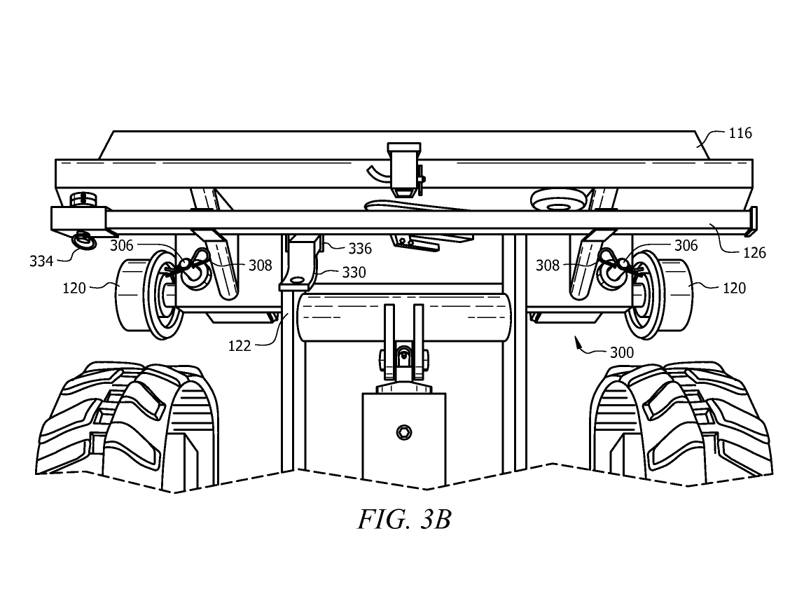

FIG. 3A depicts a top exploded view of one embodiment of the flanged wheel assembly 300 apart from the excavator. As shown therein, the flanged wheels 120 are a part of an assembly 300 that is attached to the backfill blade structure 122 by attaching members 302 that engage with corresponding receiving holes 304. The attaching members 302 also have receiving holes 306 that can receive split pins 308 that retain the flanged wheels on the backfill blade structure 122.

FIG. 3A also depicts a structure for storing a tow bar 126 on the backfill blade structure. Therein are depicted tow bar storage mounts 332 that hold the tow bar 126 in place behind the backfill blade 116. Pin 334 can be used to hold the tow bar in place while not in use. The backfill blade support structure may also include a hitch receiving slot 336 for holding a tow hitch 330. FIG. 3A also depicts a tow bar receiver 310 affixed to the top of the backfill blade 116.

FIG. 3B depicts a top view of one embodiment of the flanged wheel assembly 300 engaged with the backfill blade structure 122. The attaching members 302 are engaged with the receiving holes 304 of the backfill blade structure 122, and the split pins 308 are engaged with the receiving holes 306 of the attaching members 302.

In practice, upon arrival at a worksite, an operator can locate a place at the worksite to rest the flanged wheel assembly where it will be out of the way of the other workers. The operator can then maneuver the excavator such that the removable flanged wheel assembly is above the chosen resting place, and then lower the backfill blade structure until the wheels or wheel assembly engage the resting place. The operator or a helper can then remove the split pins from the attaching members, and the operator can then lift the backfill blade until removable wheel assembly disengages from the backfill blade structure. The operator will then have full range of motion for the backfill blade, and can timely and efficiently complete the work needed at the worksite. At the end of the day, the operator can return to the wheel assembly, line up the backfill blade structure with the removable wheel assembly, and lower the backfill blade until the removable wheel assembly reengages with the backfill blade structure. The split pins are replaced and the excavator can be run on the railroad track as described above.

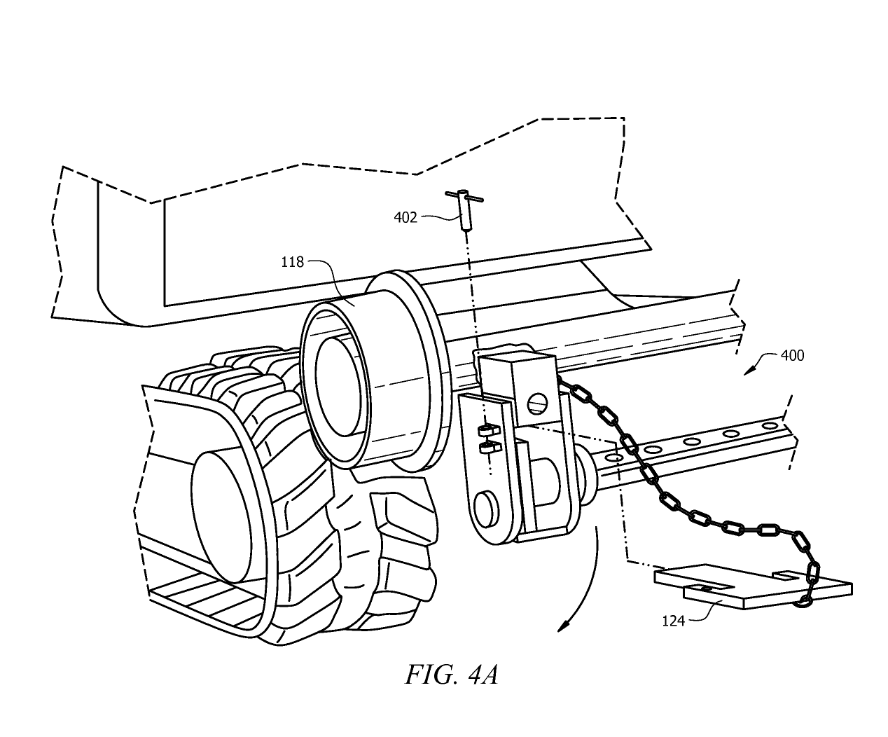

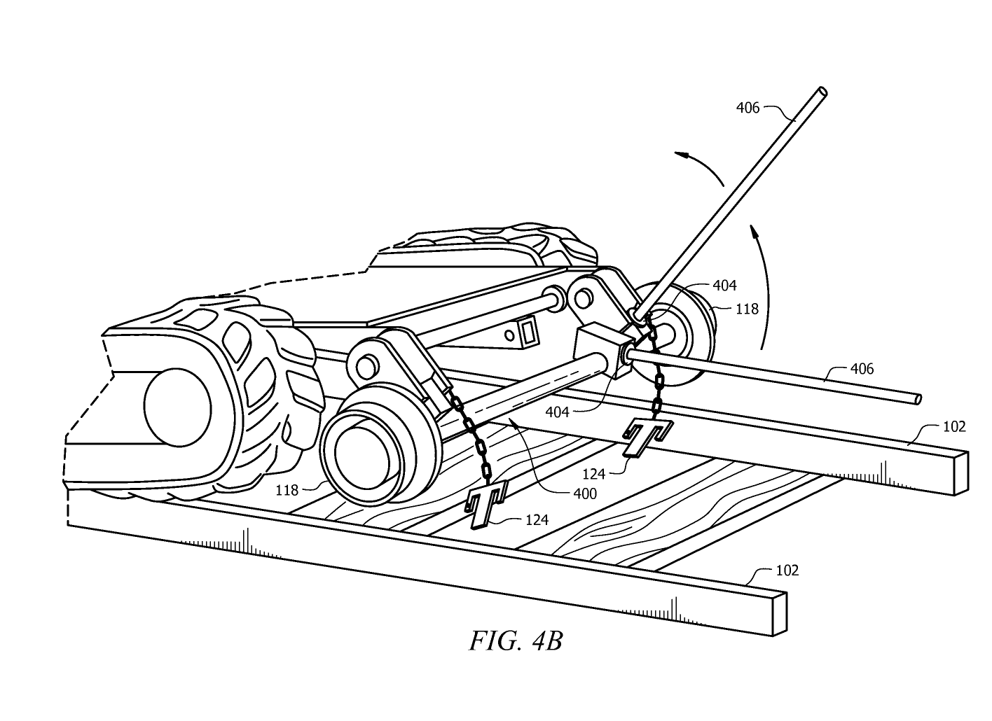

FIGS. 4A and 4B show a perspective view of the retractable flanged wheel assembly 400 in one embodiment of the present invention. FIG. 4A depicts the retractable flanged wheel assembly in their disengaged position, with the support pin 124 and safety pin 402 disengaged. As also depicted therein, the retractable flanged wheel assembly 400 is then free to rotate away from the excavator and down into the engaged position. Once in the engaged position, the support pins 124 and safety pins 118 can be replaced into their receiving slots to secure the flanged wheels 118 in place.

FIG. 4B depicts the retractable flanged wheel assembly in the process of being returned to the disengaged position. As depicted therein, the support pins have been removed from their slots, and the assembly is being rotate up towards the disengaged position. Advantageously, the retractable flanged wheel assembly includes at least one receiving hole 404 for insertion of a leverage bar 406. The metal assembly around the retractable flanged wheels must be sturdy enough to support the weight of the excavator, so it will typically be very heavy. Because it is engaged and disengaged manually in this embodiment, leverage bars can be a significant aid in lifting and rotating the wheel assembly back to the disengaged position. FIG. 4B depicts the use of two leverage bars, but any number can be used. The second leverage bar depicted in FIG. 4B would be inserted after the first leverage bar has enabled the user to partially rotate the assembly up towards the disengaged position.

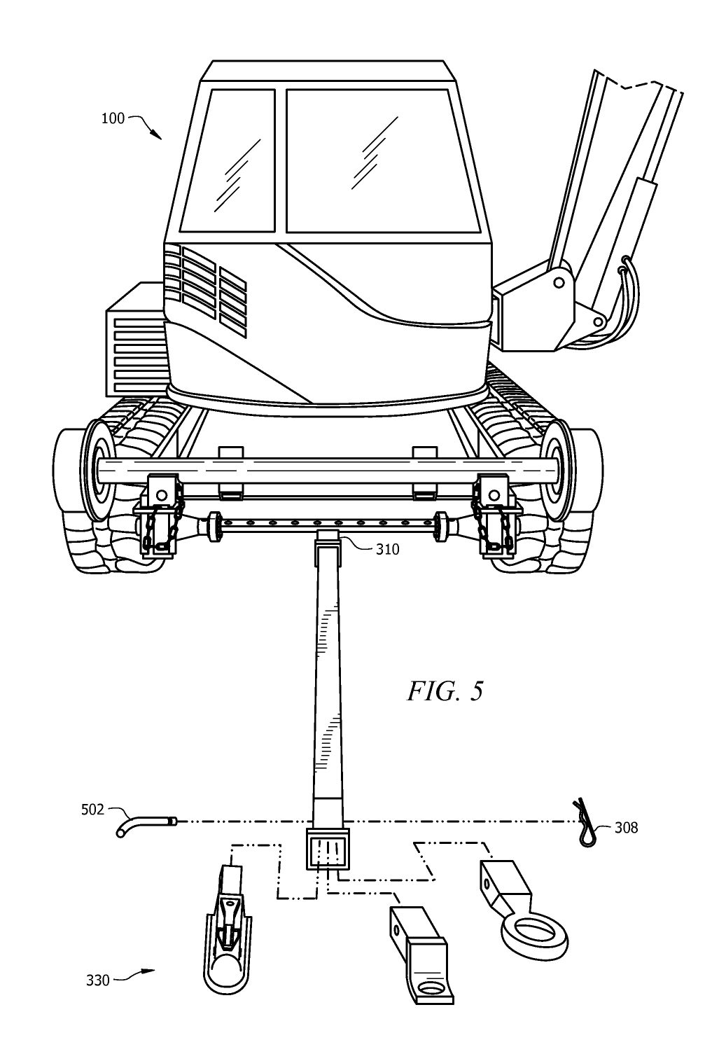

FIG. 5 is a front view of the tow bar engaged with the undercarriage. As depicted therein, various different types of tow hitches can be affixed to the end of the tow bar 126 opposite the excavator. In a preferred embodiment, the hitch 330 can be affixed to the tow bar 126 by a bent rod 502 that engages both the tow bar 126 and hitch 330, and is held in place by a split pin 308. A bent rod and split pin may also be used to affix the tow bar 126 to the excavator undercarriage structure at a tow bar receiver 310.

The invention has been described above with reference to specific embodiments. Minor changes can be made to the form and structure of the various components so long as the excavator functions in the ways described. In its most basic sense, the present invention is an excavator with a backfill blade side, one set of removable flanged wheels affixed to said backfill blade side, and one set of retractable flanged wheels affixed to a side of said excavator opposite said backfill blade side. In a preferred embodiment, the excavator further comprises a tow bar receiver.

In another embodiment, the removable flanged wheels are a part of a removable flanged wheel assembly that causes both flanged wheels to be removed at the same time. In a preferred embodiment, the removable flanged wheel assembly removably attaches to a backfill blade structure. This embodiment allows for easy alignment of the removable flanged wheels with the backfill blade structure, and thereby easy attachment and detachment of the assembly from the blade structure. Alternatively, the removable flanged wheels are removably attached to the excavator as separate pieces.

In one embodiment, the retractable flanged wheels are part of a retractable flanged wheel assembly that causes both flanged wheels to move from an engaged and disengaged position at substantially the same time. In an alternative embodiment, the retractable flanged wheels are affixed to the excavator as separate assemblies that allow each wheel to move from engaged position to disengaged position separately. In a preferred embodiment, the retractable wheel assembly or assemblies rotate between the engaged and disengaged position. However, other operable structures can be used, such as wheels assemblies that slide vertically between an engaged and disengaged position. In one embodiment, the retractable wheels are manually actuated between the engaged and disengaged position, but in another embodiment they are hydraulically actuated.

While the invention has been particularly shown and described with reference to a preferred embodiment, it will be understood by those skilled in the art that various changes in form and detail may be made therein without departing from the spirit and scope of the invention.

What is claimed is:

1. An excavator:
a backfill blade side;
a set of removable flanged wheels attached to said excavator on said backfill blade side; and
a set of retractable flanged wheels attached to said excavator on a side opposite said backfill blade side.

2. The excavator of claim 1 wherein said removable flanged wheels comprise a removable flanged wheel assembly that attaches to a structure supporting a backfill blade on said backfill blade side.

3. The excavator of claim 1 wherein said retractable flanged wheels comprise a retractable flanged wheel assembly which rotates said retractable flanged wheels between an engaged position and a disengaged position.

4. The excavator of claim 2 wherein said removable flanged wheel assembly comprises at least one attaching member that engages with at least one corresponding receiving hole in said structure supporting said backfill blade.

5. The excavator of claim 3 wherein at least one support pin holds said retractable flanged wheel assembly in said engaged position and said disengaged position.

6. The excavator of claim 1 further comprising a tow bar receiver.

7. The excavator of claim 1 further comprising a tow bar mount.

8. The excavator of claim 7 wherein said tow bar mount is integral to a support structure supporting a backfill blade.

9. The excavator of claim 6 wherein said tow bar receiver is affixed to the top of a backfill blade.

10. The excavator of claim 6 wherein said tow bar receiver is affixed to said excavator on said side opposite said backfill blade side.

11. The excavator of claim 9 further comprising a second tow bar receiver affixed to said excavator on said side opposite said backfill blade side.

12. The excavator of claim 7 further comprising a tow hitch mount.
